(19) United States
(12) Patent Application Publication
(10) Pub. No.: US 2004/0223054 A1
(43) Pub. Date: Nov. 11, 2004

(54) Multi-purpose video surveillance

(76) Inventor: Ben Aaron Rotholtz, Yarrow Point, WA (US)

Correspondence Address: FISH & RICHARDSON PC, 225 FRANKLIN ST, BOSTON, MA, 02110, US

(21) Appl. No.: 10/430,583

(22) Filed: May 6, 2003

(51) Int. Cl. H04N 7/18

(52) U.S. Cl. 348/143; 348/150

(57) ABSTRACT

A method in a video surveillance security network includes capturing video images from cameras as digital data, audio data from audio devices and/or sensor data from sensors, scanning the data for a peripheral item, determining whether the peripheral item triggers a tangential event and processing the tangential event in response to determining.

### BACKGROUND

This invention relates to multi-purpose video surveillance.

Surveillance systems record video images, audio and/or data from one or more cameras, closed circuit televisions systems and/or sensors. Surveillance systems allow time sequential visual records to be stored as analog signals on videotape or digital data in a computer memory for review and analysis. Installation of surveillance systems have traditionally been driven by the insurance industry and are often an impediment to economic productivity for major infrastructures, such as the rail industry, and ports and major transit systems, due to their high cost, restrictive nature by design and singular application.

### DESCRIPTION OF DRAWINGS

FIG. 1 is a block diagram of a network video surveillance system.

FIG. 2 is a flow diagram of the multi-purpose video surveillance process of FIG. 1.

FIG. 3 is an example GUI of a communications application of the multi-purpose video surveillance process.

FIG. 4 is an example GUI of a transportation application of the multi-purpose video surveillance process.

FIG. 5 is an example GUI of a transit application of the multi-purpose video surveillance process.

FIG. 6 is an example GUI of a facilities application of the multi-purpose video surveillance process.

### DETAILED DESCRIPTION

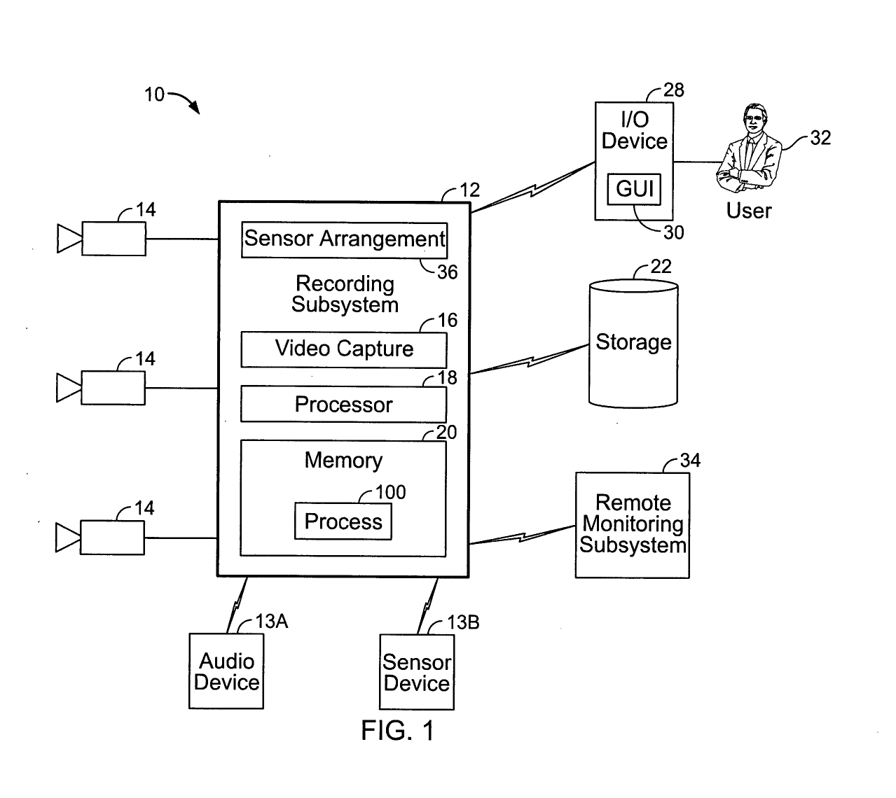

In FIG. 1, an exemplary network surveillance system 10 includes a recording subsystem 12 connected to cameras 14, such as CCTV (closed circuit television) cameras, which are positioned to provide video monitoring of a predetermined area. Recording subsystem 12 is also connected to an audio device 13A and a sensor device 13B. Recording subsystem 12 is typically installed on a site in a non-conspicuous location. Recording subsystem 12 can include a stand-alone personal computer (PC) configured with at least a video capture board 16, processor 18, memory 20, and one or more storage systems 22. Memory 20 includes a multi-purpose surveillance process 100, described below. In the example shown, recording subsystem 12 operates as a digital replacement for analog video-cassette recorders typically employed in CCTV systems. An advantage of a digital distribution system such as system 10 is it can be publicly distributed, for example, to warn a community about an impending risk. An input/output device 28 is optional and can be included to display a Graphical User Interface (GUI) 30 to a user 32.

In an example, a remote monitoring subsystem 34 can be included and programmed to allow a user to directly access the recording subsystem 12 from a remote location. In another example, the user 32 has direct access to the recording subsystem 12.

Recording subsystem 12 is programmed to continually capture video images provided by each camera 14 as digital data, audio data from the audio device 13A, and sensor data from the sensor device 13B. Captured data can be compressed using suitable data compression techniques to reduce the size of the data. The compressed image, audio or sensor data is stored as an image, audio or data file in memory 20. Identifying information (generally referred to as metadata), such as date and time of the original image, image size, audio data, sensor data and a camera identifier can be stored within the compressed image file, audio file or sensor data file or in a separate but related catalog data file.

Capture board 16 receives and converts an incoming video signal stream of pixel values and other attributes that represent the image, such as brightness and color. Capture board 16 receives audio data and sensor data. The capture board 16 transfers the pixel values as image data, audio data and/or sensor data to memory 20 for temporary storage or to a digital media delivery server (not shown) for immediate viewing, locally or remotely, and archiving. The image, audio or sensor data stored in memory 20 can be transformed using video and/or audio compression processing such as Joint Photographic Experts Group (JPEG), H.261 (video coding standard published by International Telecom Union) and Moving Picture Experts Group (MPEG), and the transformation results are compressed in accordance with a bit-encoding scheme. The compressed data can be selectively stored as a new file in storage 22 or added to an existing stored file. The stored image, audio and/or sensor files allow information recorded over pre-determined lengths of time to be organized and accumulated for retrieval and analysis. Once an existing image, audio or sensor file becomes completely filled, all corresponding catalog data is preferably appended to the same file, and closed to any further recording. A new image, audio or sensor file is subsequently opened in memory 20. Data remaining in memory 20 that is not recorded to storage 22 is ultimately written over by subsequent data.

Captured and compressed images, audio or sensor data are continually recorded into the memory 20, and subsequently stored, and selectively recorded into storage 22 upon detecting a triggering or tangential event. The same data can be locally or remotely monitored, as well directly accessed from the system 10. A triggering or tangential event can be any activity detected by a hardware or processing device. Examples of triggering or tangential events include transactions at point-of-sale (POS) terminals and automated banking teller machines (ATM), anomalies with inventory tracking and billing manifests, output signals from motion sensors, intrusion detection systems and security alarms, or a control signal sent by a remote computer system. Suitable detecting apparatus is denoted as a sensor arrangement 36, and detects the occurrence of at least one of the above-identified triggering events and provides a corresponding output signal for input to recording subsystem 12. More specifically, the same system 10 can be used to pull and store metadata from non-surveillance systems and the same image, audio and/or sensor data that are recorded for surveillance can incorporate non-surveillance data as metadata within the same file.

The digital capabilities of the recording subsystem 12 enable, for example, multiple systems (not shown) linked to system 10 to insert metadata and work in parallel or in conjunction with the system 10 to aggregate content. This capability is present in the Helix Producer encoding system, the Helix Universal Server media delivery system and the RealOne® Player interface from RealNetworks, Inc. of Seattle, Wash., in which various systems spawn metadata or contextual links that can be tied to an audio and video subsystem. The RealNetworks Helix digital media delivery system provides encoding, encrypting, distributing (e.g. downloading, streaming, transmitting), tracking, receiving, decoding, playing and organizing audio, video, text and other media and data via local and global computers, cable, satellites, wireless and mobile networks.

Most audio and video clips that play in RealOne® Player are encoded as RealAudio® data and RealVideo® data, although RealOne® Player supports over fifty additional media and data type formats, such as MPEG-1, MPEG-2 and MPEG-4 video, as well as MPEG-1 Audio Layer-3 (MP3) audio. To generate streaming clips, one starts with a digitized audio and video file in a standard, uncompressed format. On Windows, WAV (.wav) and Audio Video Interleaved (.avi) are common audio and video formats, respectively. In the Macintosh, QuickTime (.mov) and Audio Interchange File Format (.aiff) are commonly used. UNIX users often use MPEG (.mpg, .mpeg) format. The Helix Producer is capable of encoding National Television Standards Committee (NTSC) or Phase Alternation Line (PAL) signals directly to generate compressed audio and video content.

The system 10 can insert metadata or react to metadata at any stage, from content generation, encryption, rights management settings, distribution, and broadcast management through playback. The same surveillance system 10 can be used for training and inventory management. The system 10 is used for non-security surveillance applications, such as inventory control, training, consumer purchase behavior, safety and maintenance, broadcast warnings or news alerts.

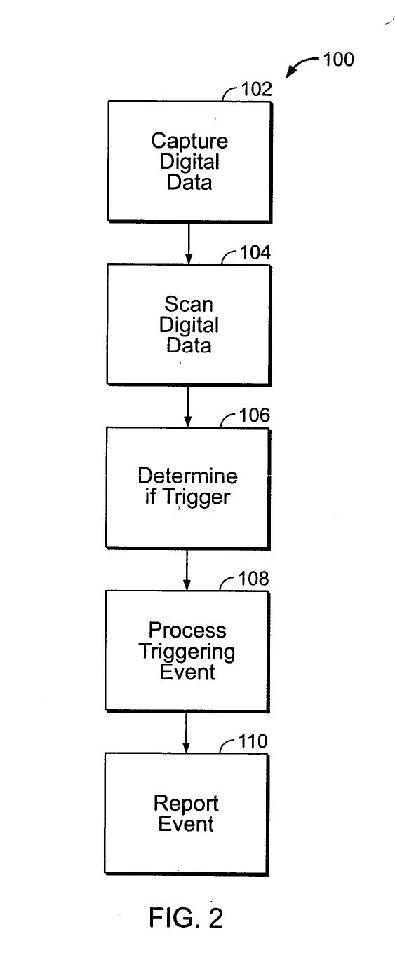

In FIG. 2, the multi-purpose surveillance process 100 includes capturing (102) video images, audio data and/or sensor data provided by cameras, microphones and/or sensors as digital data. A camera can be any type of transmitting device that receives an image and transforms it into electrical impulses. The process 100 scans (104) the digital data for peripheral events (also referred to as peripheral items). A peripheral event (or item) includes events not directly associated with security threats. For example, a peripheral event (or peripheral item) can be scanning a rail car for inventory control information, such as car location and specific blocking, and identifying car location against a shipping manifest. A peripheral event (or item) can occur in the context of a safety inspection, e.g., identifying a missing spring or other safety aberration that can result in an accident. Peripheral events (or items) for other systems can include identifying lost baggage during a scan of an airport while simultaneously surveying for planted explosives. Event simulation or secure training can be another utilization of the same surveillance system 10. Other peripheral events (or items) can include, but are not limited to, monitoring customer buying patterns or cross-checking employee patterns while the usage of the same system 10 is to monitor for shoplifting.

An advantage in utilizing the same system 10 for multiple purposes is the integrity and service quality of the security system 10 can be exercised and maintained daily, not just during a rare instance when a security breach occurs. Another advantage is that the same system 10 delivers economic advantage by delivering value against other business needs. Still another advantage is that the system 10 opens up new insight into security methodologies and proactive security assessment and response. For example, an abandoned bag in an airport can be a bomb threat or simply a lost bag in need of a customer service system that re-unites the bag with its owner. A visibly needed repair on a damaged train discovered by a video surveillance system can result in a catastrophic accident regardless of whether the damage was intentional or by accident. Furthermore, by uniting multiple systems, an expansion of data collection and analysis establishes an opportunity for pattern recognition of data anomalies across multiple systems that only in a shared form can indicate potential or imminent threats.

The process 100 determines (106) whether the digital data triggers an event. For example, an event can be a scan of a rail car that indicates damage such as a missing spring or a scan of planted explosives at an airport that may be nothing more than a customer's lost baggage. The process 100 processes (108) triggered events. In the example of a rail car scan, processing (108) involves identifying the proper maintenance and safety check people, along with other potentially germane data such as the engineer driving, the train past stops, inventory manifests and so forth. In the example of the airport scan, processing (108) identifies airport security guards and customer service representatives closest to the abandoned baggage. Process 100 reports (110) the processed triggered events.

Process 100 applies a digital over IP broadcast system overlay to the field of security and surveillance. For example, the Helix Universal platform is one example backbone of an open, standards-compliant distribution network. The encoding, encryption rights management and playback technologies that make up the Helix Universal digital broadcast system are designed to be readily integrated with a wide variety of systems. In the field of surveillance that means, for example, a doorway entry or access card reader can directly insert metadata into an audio and/or video stream. Digital capabilities enable multiple systems to insert metadata and work completely in parallel or directly in conjunction with audio, video and sensor surveillance monitoring to aggregate content.

Process 100 uses audio, video and/or data content with contextual links to increase the relevance and value of content as well as the value of data. In other examples, process 100 can be used as both a backbone for a medical imaging system and as a surveillance system. The same system 10 is used for surveillance and provides two-way audio and video, encrypted and rights managed conferencing between radiologists, while a patient is being examined. Process 100 can be used simultaneously to broadcast medical imaging technology for educational purposes to medical students at remote locations. Processing (108) can include additional data, such as patient statistics, diagnostics, billing information and medical student test scores. Thus, process 100 provides an ability to analyze audio, video and sensor content in context of other systems that are not directly related.

Process 100 can be used to integrate a security surveillance system 10 with a number of related systems. Example related systems include inventory management systems, financial management systems, retail sales systems, consumer purchase behavior systems, customer service systems, just-in-time manufacturing systems, quality control systems, and remote diagnostics systems. Other related systems include traffic and transit systems, lost baggage systems, weather services, notifications, warnings and alarms, consequence management systems, event simulation and modeling systems, training, distance learning, news broadcast and medical imaging systems.

For example, the security surveillance system 10 can be used for video surveillance and for improper inventory blocking on a rail car to identify a potentially dangerous anomaly and, with the aid of a predictive system, automate generation of a potentially hazardous impact zone and prepare other systems for consequence management and response. In this example, the system 10 is multifunctional. System 10 provides surveillance. System 10 also comparatively matches an inventory manifest with a live video record of the train. System 10 flags a potential problem according to a set of rules, for example, a chlorine container car must never be less than four cars away from a liquefied petroleum car. System 10 utilizes wind, weather and terrain and the nature of the hazard to enable a predictive analysis tool to provide proactive consequence management.

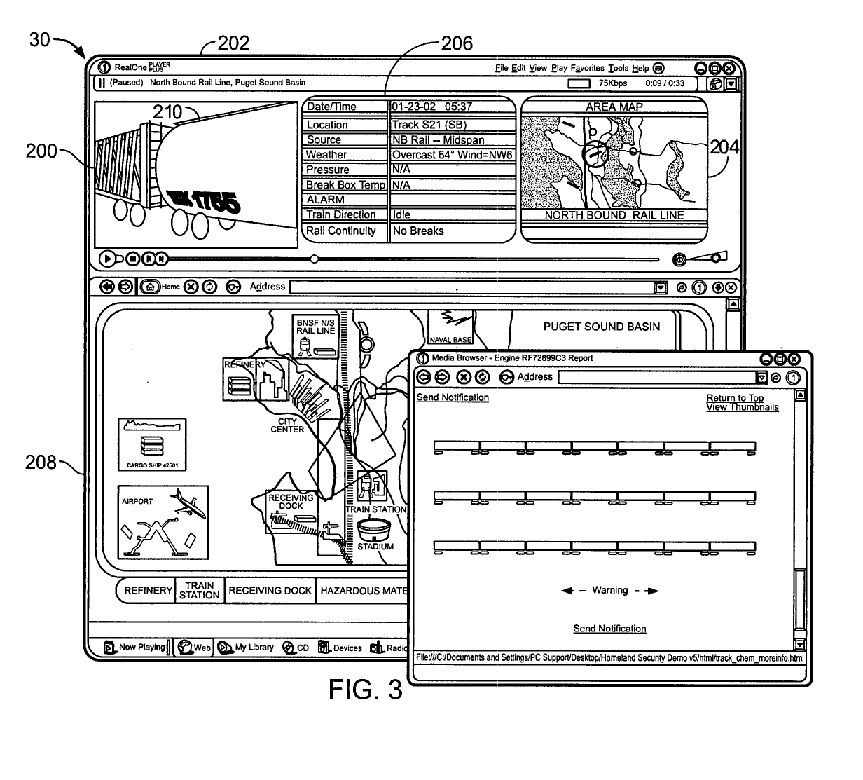

In FIG. 3, the GUI 30 illustrates an exemplary customer communication scenario of the process 100. Video and related links appear in the upper left hand corner of the screen 202. At the top and to the right are contextual inputs; maps 204 or metadata 206 amplify the value of the media. Below the screen 202 is a browser pane 208 to enable the ready integration of any HTML pages or applications.

Command centers for emergency management may want to survey multiple infrastructures to aggregate a comprehensive understanding of the environment. For example, a train 210 that is carrying hazardous material may thread its way from a chemical processing plant, through loading docks, and then through a community with multiple infrastructures. At any given point in time, it is valuable to understand a hazardous material car in context of its surrounding environment. For example, rail continuity, weather and wind conditions, people associated with the loading, handling and transit of the chemical agent and environmental sensors from the car's current location. Some of the information, such as the owner of the car, is fixed. Most inputs, such as current location and weather, are dynamic.

Process 100 can trigger an alarm. For example, the alarm can indicate that a chlorine container car is improperly positioned next to a liquefied petroleum car. Process 100 uses video inspection of the cars and then compares it against an actual train manifest. Predictive analysis can proactively determine an exposure plume should an accident occur. Process 100 can be used for consequent management to alert responsible entities to correct the problem or respond to an accident that can affect a range of community infrastructures. The conversion of multiple data and media inputs results in a powerful tool for live monitoring, forensic analysis and consequent management.

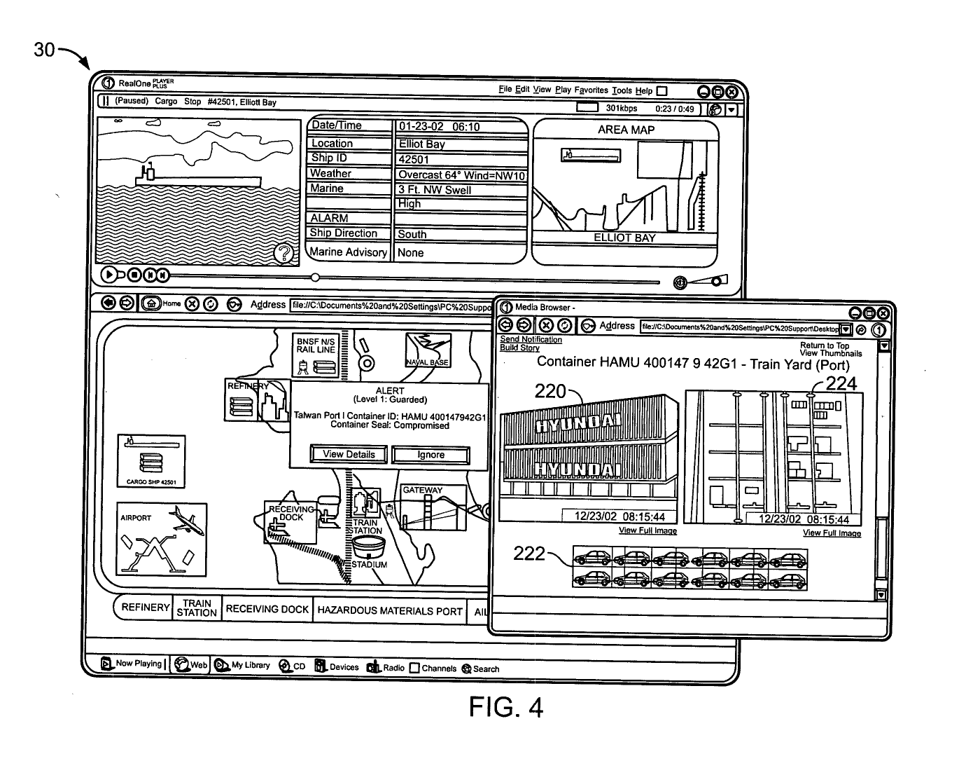

In FIG. 4, the Graphical User Interface (GUI) 30 illustrates an exemplary transportation scenario of the process 100. Commercial transportation systems include both fixed and mobile assets designed in concert to efficiently expedite cargo from point to point. Homeland security raises awareness of the inherent vulnerabilities within the massive, multi-point commercial transportation systems. At any given moment a breakdown in the command transportation system can result in catastrophic damages.

Process 100 enables the immediate convergence of surveillance media and input data to comparatively and deeply understand assumed conditions. In this example, tamper resistant container seals 220 should be locked and a gamma ray scan 222 of the container should indicate integrity. A changed state of broken container seals 224 and suspicious additions to the container car based on an updated gamma ray scan is seen. Process 100 unites complete information and environmental conditions that can then be forwarded to appropriate agencies so that appropriate teams are sufficiently equipped to respond with precision in the event of emergency.

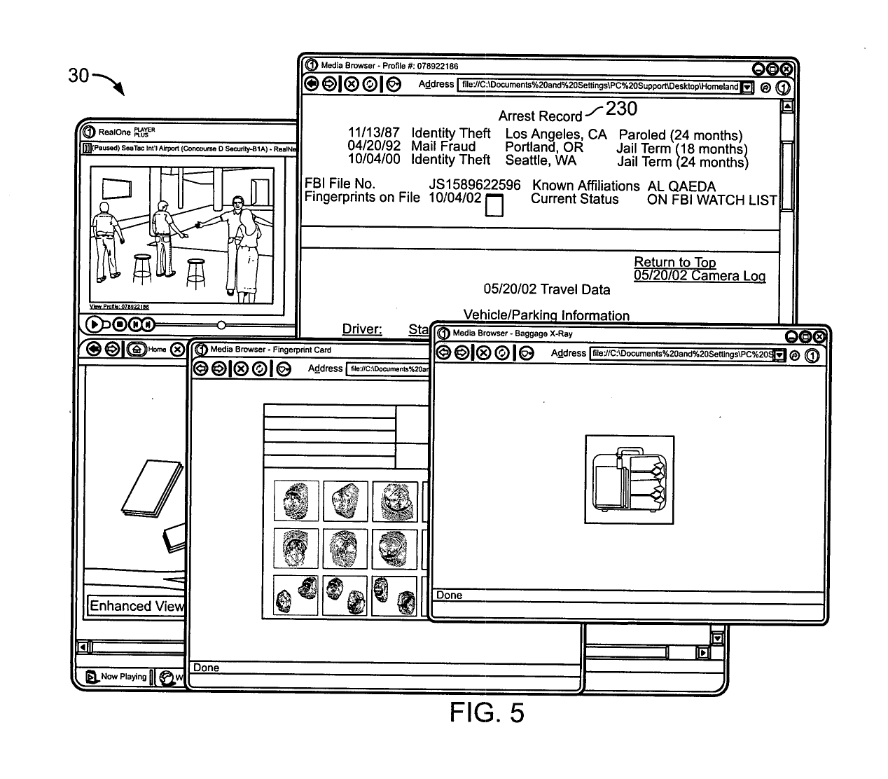

In FIG. 5, the GUI 30 illustrates an exemplary transit scenario of the process 100. Homeland security demands a high level of converged information for transit systems. For example, a potential threat can originate from a license plate captured on video at an airport perimeter. Process 100 can extract the license plate number from the video, compare the license to Department of Motor Vehicle and Federal Bureau of Investigation (FBI) 230 records and then automatically issue a system-wide alert to monitor the vehicle occupants.

Starting with the initiation of this warning a full characterization can be assembled, pulling relevant information from multiple systems and combining it with video and data records of flight check-ins, baggage and security screening. Secure, system-wide alerts with complete and exacting information are made to other airport facilities. The vigilance of process 100 and the aggregation of media and data results in heightened awareness and confidence. An alert issued from process 100 can be issued with media and data to a broad array of affordable mobile devices to strengthen the knowledge of airport security, sky marshals and law enforcement. Additionally, the same surveillance system can improve transit efficiencies to look for lost baggage or missing persons.

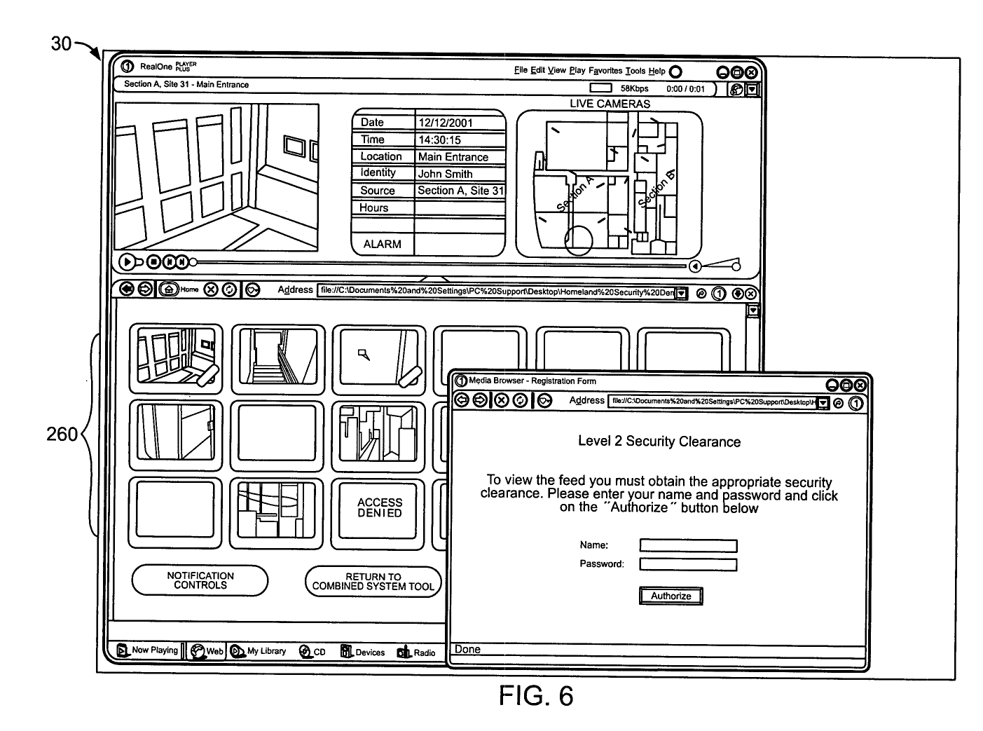

In FIG. 6, the GUT 30 illustrates an exemplary facilities scenario of the process 100. A new facility typically has multiple systems 260, such as intrusion detection, smoke and fire sensors with centralized monitoring, video surveillance, access control, card key readers, authentication systems and perhaps even biometrics controls for iris, fingerprint or voice recognition. Behind the scenes are system controls and databases. Process 100 automates the convergence and analysis of data and media for all of these systems. Should an anomaly occur, notifications available through network systems can be used to send law enforcement a synthesis of that information. Encryption and digital rights management of the information is confidently delivered to a personal computer with, for example, a RealOnePlayer®. The rights to view that information at a particular time for a defined duration and for a set number of uses are all rights that one controls for media delivery. The range and flexibility of devices enables a new era for security and surveillance. Affordably, one can link local law enforcement and proactively enable direct video surveillance from portable and mobile devices located locally or from thousands of miles away.

The invention can be implemented in digital electronic circuitry, or in computer hardware, firmware, software, or in combination of them. The invention can be implemented as a computer program product, i.e., a compute program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form pf programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. Accordingly, other embodiments are within the scope of the following claims.

What is claimed is:

1. A method in a video surveillance security network comprising:
capturing video images from cameras as digital data;
scanning the digital data for a peripheral item;
determining whether the peripheral item triggers a tangential event; and
processing the tangential event in response to determining.

2. The method of claim 1 further comprising reporting the tangential event.

3. The method of claim 1 in which the peripheral item is inventory related.

4. The method of claim 1 in which the peripheral item is safety and maintenance related.

5. The method of claim 1 in which the peripheral item is news broadcast related.

6. The method of claim 1 in which the peripheral item is radiological imaging related.

7. The method of claim 1 in which the peripheral item is learning management related.

8. The method of claim 1 in which the peripheral item is customer service related.

9. The method of claim 1 in which processing comprises flagging the tangential event according to a set of rules.

10. The method of claim 1 in which processing comprises applying a predictive analysis to provide proactive consequence management.

11. The method of claim 1 in which the tangential event includes transactions at point-of-sale (POS) terminals and automated banking teller machines (ATM), anomalies with inventory tracking and billing manifests, output signals from motion sensors, intrusion detection systems and security alarms, or a control signal sent by a remote computer system.

12. A multipurpose video network surveillance method comprising:
capturing video images from a camera as digital data; and
processing a peripheral item if the peripheral item triggers an event.

13. The method of claim 12 in which capturing further comprises a plurality of cameras.

14. The method of claim 12 in which the peripheral item is an inventory item.

15. The method of claim 12 in which the peripheral item is a safety and maintenance item.

16. The method of claim 12 in which the peripheral item is a news broadcast item.

17. The method of claim 12 in which the peripheral item is a radiological imaging item.

18. The method of claim 12 in which the peripheral item is a learning management item.

19. The method of claim 12 in which the peripheral item is a customer service item.

20. The method of claim 12 in which processing comprises applying a predictive analysis to provide proactive consequence management.

21. The method of claim 12 in which processing comprises reporting the peripheral event.

22. The method of claim 12 in which processing comprises recommending a course of corrective action.

23. A computer program, tangibly stored on a computer-readable medium, comprising instructions operable to cause a computer to:
capture video images as digital data from cameras deployed in a video surveillance security network;
scan the digital data for a peripheral item; and
process a tangential event if the peripheral item triggers an event.

24. The program of claim 23 in which the tangential event includes transactions at point-of-sale (POS) terminals and automated banking teller machines (ATM), anomalies with inventory tracking and billing manifests, output signals from motion sensors, intrusion detection systems and security alarms, or a control signal sent by a remote computer system.

25. A system comprising:
a video surveillance camera;
a video capture circuit coupled with the video surveillance camera to capture digital video images;
a device to compress the captured digital video images; and
a memory for storing a triggering event in the compressed digital video images.

26. The system of claim 25 further comprising a link to a remote monitoring system.

27. The system of claim 25 further comprising links to multiple systems.

28. The system of claim 25 further comprising links to a plurality of video surveillance cameras.

29. A method comprising:
collecting security data from video images captured by a video surveillance security camera as digital data;
collecting peripheral data from the video images captured by the video surveillance camera as digital data;
determining whether the peripheral data triggers a tangential event; and
processing the tangential event in response to determining.

30. The method of claim 29 further comprising reporting the tangential event.

31. The method of claim 29 in which the peripheral data is an inventory item.

32. The method of claim 29 in which the peripheral data is a safety and maintenance item.

33. The method of claim 29 in which the peripheral data is a news broadcast item.

34. The method of claim 29 in which the peripheral data is a radiological image item.

35. The method of claim 29 in which the peripheral data is a learning management item.

36. The method of claim 29 in which processing comprises flagging the tangential event according to a set of rules.

37. The method of claim 29 in which processing comprises applying a predictive analysis to provide proactive consequence management.

38. The method of claim 29 in which processing comprises:
loading data from a remote database; and
combining the data with the peripheral data.

39. The method of claim 29 in which the tangential event includes transactions at point-of-sale (POS) terminals and automated banking teller machines (ATM), anomalies with inventory tracking and billing manifests, output signals from motion sensors, intrusion detection systems and security alarms, or a control signal sent by a remote computer system.

40. A video capture method comprising:
receiving video images as digital data from a network surveillance camera;
collecting security information from the digital data;
collecting non-security information from the digital data; and
processing the non-security information if the non-security information triggers a peripheral event.

41. The method of claim 40 in which receiving further comprises a plurality of video surveillance cameras.

42. The method of claim 40 in which the non-security information is an inventory item.

43. The method of claim 40 in which the non-security information is a safety and maintenance item.

44. The method of claim 40 in which the non-security information is a new broadcast item.

45. The method of claim 40 in which the non-security information is radiological imaging item.

46. The method of claim 40 in which the non-security information is a learning management item.

47. The method of claim 40 in which the non-security information is a customer service item.

48. The method of claim 40 in which processing comprises applying a predictive analysis to provide proactive consequence management.

49. The method of claim 40 in which processing comprises reporting the non-security information.

50. The method of claim 40 in which processing comprises recommending a course of action.

51. The method of claim 40 in which processing comprises:
loading data from a remote database; and
combining the data with the non-security information.

52. The method of claim 40 in which processing comprises:
loading data from a plurality of remote databases; and
combining the data with the non-security information.

53. A method in a surveillance security network comprising:
capturing video images from cameras as digital data;
capturing audio data from audio devices;
capturing sensor data from sensors;
scanning the digital data, audio and sensor data for a peripheral item; and
processing the peripheral item if the peripheral item triggers a tangential event.

54. The method of claim 53 in which capturing further comprises incorporating metadata from the other sources into the video digital data, the audio data and the sensor data.

55. The method of claim 53 further comprising reporting the peripheral item.

56. The method of claim 53 in which the tangential event includes transactions at point-of-sale (POS) terminals and automated banking teller machines (ATM), anomalies with inventory tracking and billing manifests, output signals from motion sensors, intrusion detection systems and security alarms, or a control signal sent by a remote computer system.
